(19) United States
(12) Patent Application Publication
(10) Pub. No.: US 2005/0175850 A1
(43) Pub. Date: Aug. 11, 2005

(54) Flexible metal laminate and heat-resistant adhesive composition

(75) Inventors: Ichirou Koyano, Shizuoka-ken (JP); Akihiro Maeda, Shizuoka-shi (JP); Yuusuke Suzuki, Shida-gun (JP); Ken Yoshioka, Shizuoka-shi (JP)

Correspondence Address: WOOD, HERRON & EVANS, LLP, 2700 CAREW TOWER, 441 VINE STREET, CINCINNATI, OH, 45202, US

(73) Assignee: Tomoegawa Paper Co., Ltd, Tokyo (JP)

(21) Appl. No.: 10/513,726

(22) PCT Filed: Nov. 18, 2003
(86) PCT No.: PCT/JP03/14678

(30) Foreign Application Priority Data
Nov. 20, 2002 (JP) 2002-336693
Nov. 20, 2002 (JP) 2002-337065

(51) Int. Cl. B32B 15/08; B32B 27/42

(52) U.S. Cl. 428/458; 428/460

(57) ABSTRACT

An object of the present invention is to provide a flexible metallic layered product preferably used for a flexible printed board for flip chip bonding, which is required to have high heat resistance and pressure resistance by improving heat resistance of the flexible metallic layered product, in particular, improving heat resistance of the layer contacting the metallic layer, and a heat resistant adhesive composition. In order to achieve the object, the present invention provides a flexible metallic layered product comprising at least a three-dimensional cross-linking type thermosetting resin layer and a thermoplastic resin layer are layered on a metallic layer in this order. In particular, when a ratio (t1/t2) between the thickness (t1) of the three-dimensional cross-linking type thermosetting resin layer and the thickness (t2) of the total resin layers, which are layered on the metallic layer, is in a range from 7/100 to 85/100, heat resistance of the total resin layers, which are layered on the metallic layer, is more improved.

### TECHNICAL FIELD

This invention relates to a flexible metallic layered product and to a heat-resistant adhesive composition, which are used for a flexible printed circuit board, in particular, a flexible printed circuit board comprising a circuit formed by a flip chip bonding method which is required to have high heat resistance.

### BACKGROUND ART

Recently, portable telephones, crystal liquid monitors, etc., are widely used. Electric elements have been desired to be small, thin, and be multifunctional. In order to fulfill these requirements, reducing size and high integration are essential. In addition, a technique for mounting electronic elements in high density has been required. In light of the above, TAB (Tape Automated Bonding) tapes and a flexible metallic layered product, in which a copper foil is layered on an organic insulating film such as a polyimide film, etc., on which a polyamide adhesive coated, have been widely used. In particular, flexible metallic layered products having a variety of structures are marketed. Specifically, a triple layered product, in which a metallic foil is adhered to a polyimide film by an adhesive layer made of an epoxy resin and an acrylic resin, etc., a double layered product, in which a metallic layer is formed on a polyimide film by a vapor deposition method or a plating method, are mainly commercialized.

In addition, recently, in particular, reducing size of a driving IC for a liquid crystal display (LCD) and increasing the power of an IC are desired. Due to this, finer pitch technique is needed, and a flip chip bonding method is frequently used to bond an IC chip and a flexible printed circuit board. A flip chip bonding method is a method in which a circuit pattern is formed on a flexible metallic triple layered product or a flexible metallic double layered product and electrodes (gold bumps) of an IC chip are bonded to wires of the circuit pattern by applying high temperature in a range from 200 to 500° C. and high pressure in a range from 150 to 300 N/cm². Therefore, it is necessary for the flexible metallic layered product to have high temperature resistance, specifically, it must not mechanically deform and not melt, etc., in high-temperature and high-pressure conditions during the flip chip bonding.

Since a conventional flexible metallic triple layered product is produced at relative low cost and a polyimide film, which is used for the layered product, is made of a non-thermoplastic polyimide resin having excellent resistance to a solvent, and does not dissolve in a solvent, a conventional flexible metallic triple layered product has excellent resistance to high temperatures and excellent electrical properties. However, in a conventional flexible metallic triple layered product, an adhesive layer adjacent to a metallic layer has remarkably inferior resistance to heat. Therefore, a problem may occur in that the adhesive layer may deform or melt at high-temperatures and high pressures during flip chip bonding, and connection reliability remarkably decreases.

Japanese Unexamined Patent Applications, First Publication Nos. H09-148695 and 2000-103010 disclose a flexible metallic layered product comprising a polyimide resin layer having high resistance to heat, as a flexible metallic layered product which can solve this problem. However, in this flexible metallic layered product, an adhesive layer is deformed and melts after applying high temperatures and high pressures during flip chip bonding. Therefore, connection reliability of the flexible metallic layered product is deteriorated, and the flexible metallic layered product is not practically used sufficiently.

As a means for improving heat resistance of an adhesive layer, there is a means, in which a thermoplastic resin having high resistance to heat is attached to a metallic layer such as a metallic foil as an adhesive layer. However, since it is required that attaching the adhesive layer to a metallic foil be conducted under high temperature and high pressure conditions, linear expansion difference between the adhesive layer and a metallic foil arises. Due to this, a problem such as wrinkles of a metallic foil easily arises, and this creates problems in productivity.

A flexible metallic layered product obtained by a polyimide cast type production method, in which a polyimide precursor varnish is directly coated on a metallic foil, is dried, and thereby the polyimide precursor forms a polyimide, has also been suggested. In the flexible metallic layered product, before coating a polyimide precursor varnish on a metallic foil, removing solvent on the metallic foil is necessary. In addition, a step for changing a polyimide precursor to polyimide under high temperature such as about 400° C. is needed. During this step, attention must be paid to stability of size, and high level control technique is necessary. Compared with a conventional flexible metallic triple layered product, the flexible metallic layered product has superior resistance to heat, but has inferior productivity, and there is a problem in cost such as large production equipment is necessary.

Japanese Examined Patent Application, Second Publication No. S55-39242 discloses a heat resistant resin composition containing a maleimide compound and a (methyl) allylphenol compound. However, this composition has inferior resistance to impacts.

Japanese Unexamined Patent Application, First Publication No. 2001-302715 discloses a resin composition containing a special polyether ketone, a maleimide compound, and an allylphenol compound. This resin composition is reported to have improved resistance to impacts without deterioration of heat resistance. However, polyether ketone has a problem in that making a film is difficult due to rigid structure thereof. A composition containing polyether ketone has insufficient toughness and ductility for making a film, and this is unsuitable for a flexible printed circuit board.

In addition, when a thermoplastic polyimide resin having a super high glass transition point (Tg) exceeding 400° C. is, used, heat resistance is improved. However, such a resin does not readily dissolve in a solvent, and since the Tg is high, the processing temperature must be high, and workability and handling thereof are worse. Furthermore, there is a problem that an adhesive to a substrate to be coated is worse.

In consideration of these problems, it is an object of the present invention to provide a flexible metallic layered product which has high reliability, excellent workability and heat resistance, and which is preferably used for flip chip bonding method, and a heat resistant adhesive composition.

### DISCLOSURE OF INVENTION

The flexible metallic layered product of the present invention comprises at least a three-dimensional cross-linking type thermosetting resin layer and a thermoplastic resin layer are layered on a metallic layer in this order. Since heat resistant of the three-dimensional cross-linking type thermosetting resin layer on the metallic layer is superior to the heat resistant of the thermoplastic resin layer, heat resistance of an insulating layer comprising the whole resin layers on the metallic layer is improved.

In particular, it is preferable for the three-dimensional cross-linking type thermosetting resin layer to comprise a thermoplastic resin (A) having at least one imide group, a thermosetting compound (B) having at least two maleimide groups, and a compound (C) having a functional group which is reactive with the thermosetting compound (B).

### BRIEF DESCRIPTION OF THE DRAWINGS

FIG. 1 is a sectional drawing showing a flexible metallic layered product of one embodiment according to the present invention.

FIG. 2 is a sectional drawing showing another flexible metallic layered product of one embodiment according to the present invention.

### BEST MODE FOR CARRYING OUT THE INVENTION

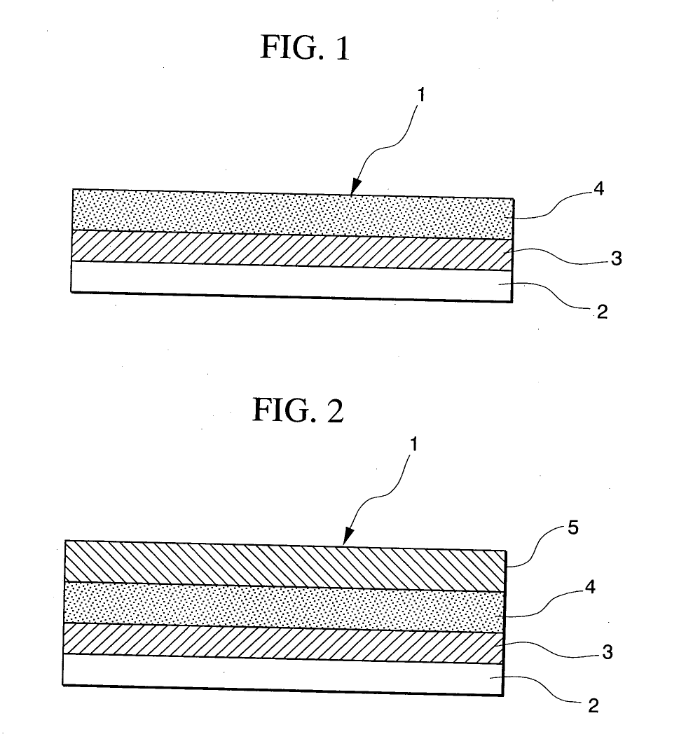

FIG. 1 is a sectional drawing showing a flexible metallic layered product of the present invention. The flexible metallic layered product 1 comprises a metallic layer 2, a three-dimensional cross-linking type thermosetting resin layer 3 and a thermoplastic resin layer 4, which are layered on the metallic layer 2 in this order. That is, in this flexible metallic layered product 1, an insulating layer comprises at least two resin layers. In the present invention, as shown in FIG. 2, an organic resin layer 5 may be layered on the thermoplastic resin layer 4.

The metallic layer 2 includes a metallic foil such as a gold foil, a silver foil, a copper foil, a phosphor bronze foil, a stainless steel foil, a nickel foil, an aluminum foil, a steel foil, a titanium foil, a foil made of an alloy of these metals, a metallic vapor deposition film, a metallic sputtering film, etc. Among these, a metallic foil is preferable, and in particular, a copper foil, a stainless steel foil, an aluminum foil, or a steel foil is preferable. The thickness of the metallic layer 2 is in a range from 3 to 50 μm, and is preferably in a range from 9 to 35 μm.

The three-dimensional cross-linking type thermosetting resin layer 3 contains a three-dimensional cross-linking type thermosetting resin having a functional group, which has reactivity and contributes a polymerization having a three-dimensional structure such as a cross-linking, and a mesh by a heat treatment.

Such a resin has preferably two or more reactive functional groups in one molecule. The reactive functional group includes an epoxy group, a phenolic hydroxyl group, an alcoholic hydroxyl group, a thiol group, a carboxyl group, an amino group, an isocyanate group, etc. A functional group having a carbon-carbon double bond such as an allyl group, a vinyl group, an acryl group, a methacryl group, etc., or a functional group having an acetylene carbon-carbon triple bond are preferable. A reactive functional group, in which or between which a reaction accompanying with an Ene reaction or a Diels-Alder reaction, is more preferable.

The three-dimensional cross-linking type thermosetting resin is preferable at least one of a maleimide derivative, a bisallylnadimide derivative, an allylphenol derivative, an isocyanurate derivative, etc. Among these, a maleimide derivative, a bisallylnadimide derivative, or an allylphenol derivative is more preferable.

The three-dimensional cross-linking type thermosetting resin layer 3 may contain a resin besides the three-dimensional cross-linking thermosetting resin. In order to easily make a film, a thermoplastic resin is preferably added.

The three-dimensional cross-linking type thermosetting resin layer 3 contains preferably a three-dimensional cross-linking type thermosetting resin, which is dissolved in a solvent, and a thermoplastic resin, which is dissolved in a solvent.

In particular, the three-dimensional cross-linking type thermosetting resin layer 3 contains more preferably a three-dimensional cross-linking type thermosetting resin having two or more reactive functional groups in one molecule and a thermoplastic resin, which is dissolved in a solvent. Such three-dimensional cross-linking type thermosetting resin layer 3 has improved heat resistance and is easily made into a film.

In particular, the three-dimensional cross-linking type thermosetting resin layer 3 is preferably made of the following heat resistant adhesive composition.

The preferable heat resistant adhesive composition contains a thermoplastic resin (A) having at least one imide group, a thermosetting compound (B) having at least two maleimide groups, and a compound (C) having a functional group which is reactive with the thermosetting compound (B).

These components are explained below.

The component (A) includes any thermoplastic resin which has at least one imide group in a repeating unit and has thermoplasticity, that is, a commercially available resin and a chemical synthesizable resin, which has at least one imide group in a repeating unit and has thermoplasticity, can be used as the component (A). Specifically, the component (A) includes a thermoplastic polyimide resin, a thermoplastic polyamide imide resin, a thermoplastic polyetherimide resin, a thermoplastic polyesterimide resin, a thermoplastic polysiloxaneimide resin, etc. These resins may each be used independently, or two or more resins may be used in combination.

Among these, a resin, which is dissolved in a solvent and which makes a film by itself, is preferably used. Specifically, a soluble polyimide resin, a soluble polyamide imide resin, a soluble siloxaneimide resin are preferable. Among these, a linear polymer having a repeating unit comprising a structure, in which one or two imide groups are bonded to a principal chain of a trivalent or tetravalent aromatic ring, and a structure, in which two amide groups are bonded to a principal chain of a divalent aromatic ring, and being soluble in a solvent even when this is substantially an imide compound.

The glass transition point of the component (A) is not particularly limited, but is preferably 200° C. or greater, more preferably 250° C. or greater, and most preferably 300° C. or greater. If the glass transition point of the component (A) is less than 200° C., heat resistance of the composition may be insufficient. Therefore, the component (A) having a glass transition point less than 200° C. is not preferable. The glass transition point of the component (A) is preferably 400° C. or less. If the glass transition point of the component (A) exceeds 400° C., solubility to a solvent of the composition decreases and working temperature of the composition becomes high, and thereby working efficiency and workability decreases. Therefore, the component (A) having a glass transition point exceeding 400° C. is not preferable.

The component (B) contained in the composition of the present invention is not particularly limited as long as this is a thermosetting compound having at least two maleimide groups. The component (B) includes N,N′-ethylene bismaleimide, N,N′-hexamethylene bismaleimide, N,N′-dodecamethylene bismaleimide, N,N′-m-xylene bismaleimide, N,N′-p-xylene bismaleimide, N,N′-1,3-bismethylenecyclohexane bismaleimide, N,N′-1,4-bismethylenecyclohexane bismaleimide, N,N′-2,4-tolylene bismaleimide, N,N′-2,6-tolylene bismaleimide, N,N′-3,3′-diphenylmethane bismaleimide, N,N′-4,4′-diphenylmethane bismaleimide, 3,3′-diphenylsulfone bismaleimide, 4,4′-diphenylsulfone bismaleimide, N,N′-4,4′-diphenylsulfide bismaleimide, N,N′-p-benzophenone bismaleimide, N,N′-diphenylethane bismaleimide, N,N′-diphenylether bismaleimide, N,N′-(methylene-ditetrahydrophenyl) bismaleimide, N,N′-(3-ethyl)-4,4′-diphenylmethane bismaleimide, N,N′-(3,3′-dimethyl)-4,4′-diphenylmethane bismaleimide, N,N′-(3,3′-diethyl)-diphenylmethane bismaleimide, N,N′-(3,3′-dichloro)-4,4′-diphenylmethane bismaleimide, N,N′-tolidine bismaleimide, N,N′-isophorone bismaleimide, N,N′-p,p′-diphenyldimethylsilyl bismaleimide, N,N′-benzophenone bismaleimide, N,N′-diphenylpropane bismaleimide, N,N′-naphthalene bismaleimide, N,N′-p-phenylene bismaleimide, N,N′-m-phenylene bismaleimide, N,N′-4,4′-(1,1′-diphenyl-cyclohexane) bismaleimide, N,N′-3,5-(1,2,4-triazole) bismaleimide, N,N′-pyridine-2,6-diyl bismaleimide, N,N′-5-methoxy-1,3-phenylene bismaleimide, 1,2-bis(2-maleimideethoxy)-ethane, 1,3-bis(3-maleimidepropoxy)-propane, N,N′-(2,2′-diethyl-6,6′-dimethyl-4,4′-methylenediphenylene) bismaleimide, N,N′-4,4′-diphenylmethane-bis-dimethyl maleimide, N,N′-hexamethylene-bis-dimethyl maleimide, N,N′-4,4′-(diphenylether)-bis-dimethyl maleimide, N,N′-4,4′-diphenylsulfone-bis-dimethyl maleimide, N,N′-bismaleimide of 4,4′-diamino-triphenylphosphate, N,N′-bismaleimide of 4,4′-diamino-triphenylthiophosphate, 2,2-bis[4-(4-maleimidephenoxy)phenyl]propane, 2,2-bis[3-chloro-4-maleimidephenoxy)phenyl]propane, 2,2-bis[3-bromo-4-(4-maleimidephenoxy)phenyl]propane, 2,2-bis[3-ethyl-4-(4-maleimidephenoxy)phenyl]propane, 2,2-bis[3-propyl-4-(4-maleimidephenoxy)phenyl]propane, 2,2-bis[3-isopropyl-4-(4-maleimidephenoxy)phenyl]propane, 2,2-bis[3-butyl-4-(4-maleimidephenoxy)phenyl]propane, 2,2-bis[3-sec-butyl-4-(4-maleimidephenoxy)phenyl]propane, 2,2-bis[3-methoxy-4-(4-maleimidephenoxy)phenyl]propane, 1,1-bis[4-(4-maleimidephenoxy)phenyl]ethane, 1,1-bis[3-methyl-4-(4-maleimidephenoxy)phenyl]ethane, 1,1-bis[3-chrolo-4-(4-maleimidephenoxy)phenyl]ethane, 1,1-bis[3-bromo-4-(4-maleimidephenoxy)phenyl]ethane, 1,1-bis[4-(4-maleimidephenoxy)phenyl]methane, 1,1-bis[3-methyl-4-(4-maleimidephenoxy)phenyl]methane, 1,1-bis[3-chrolo-4-(4-maleimidephenoxy)phenyl]methane, 1,1-bis[3-bromo-4-(4-maleimidephenoxy)phenyl]methane, 3,3-bis[4-(4-maleimidephenoxy)phenyl]penthane, 1,1-bis[4-(4-maleimidephenoxy)phenyl]propane, 1,1,1,3,3,3-hexafluoro-2,2-bis[4-(4-maleimidephenoxy)phenyl]propane, 1,1,1,3,3,3-hexafluoro-2,2-bis[3,5-dimethyl-(4-maleimidephenoxy)phenyl]propane, 1,1,1,3,3,3-hexafluoro-2,2-bis[3,5-dibromo-(4-maleimidephenoxy)phenyl]propane, 1,1,1,3,3,3-hexafluoro-2,2-bis[3,5-dimethyl-(4-maleimidephenoxy)phenyl]propane, etc. These maleimides may each be used independently, or two or more resins may be used in combination.

The component (C) contained in the composition of the present invention is not particularly limited as long as this has a functional group, which is reactive with the component (B). The component (C) includes a compound having a unsaturated bond such as a vinyl compound, a (methyl)allyl compound, a nadimide compound, maleimide compound, a diene compound, a compound having an amino group, etc. These compounds may each be used independently, or two or more compounds may be used in combination. In addition, it is also preferable to use at least one compound among these compounds and a cationic compound, and an organic peroxide, etc., as the component (C).

In particular, because excellent toughness and ductility are obtained without deterioration of heat resistance of the obtained compound, the component (C) is preferably a resin which is at least one of a phenol resin, an (iso)phthalate resin, and an (iso)cyanurate resin, and which has at least two functional groups of an allyl group and/or a methallyl group.

Here, a phenol resin having at least two functional groups of an allyl group and/or a methallyl group (that is, an allylphenol resin derivative) is not particularly limited, but includes a resin in which an ortho-position and/or a para-position relative to a phenolic hydroxy group of a phenol resin derivative as a raw material is substituted with an allyl group and/or a methallyl group. These allylphenolic resin derivatives may each be used independently, or two or more derivatives may be used in combination.

A phenolic resin derivative, which is a raw material of an allylphenol resin derivative, includes monovalent phenols such as phenol, o-cresol, m-cresol, p-cresol, o-chlorophenol, p-chlorophenol, o-nitrophenol, p-nitrophenol, p-aminophenol, o-methoxyphenol, p-methoxyphenol, p-acetoxyphenol, p-acetylphenol, 2,4-dimethylphenol, and 2,5-dimethylphenol; divalent phenols such as catechol, hydroquinone, biphenol, 2,2-bis(4-hydroxyphenol)propane (that is, Bisphenol A), bis(4-hydroxyphenyl)methane (that is, Bisphenol F), 4,4-dihydroxybenzophenone, 4,4-dihydroxyphenylsulfone, 3,9-bis(2-hydroxyphenyl)-2,4,8,10-tetraoxaspiro[5,5]undecane, 3,9-bis(4-hydroxyphenyl)-2,4,8,10-tetraoxaspiro[5,5]undecane, and 1,1,1,3,3,3-hexafluoro-2,2-bis(p-hydroxyphenyl)propane (that is, hexafluoro Bisphenol A); and polyvalent phenols such as phenol novolac, cresol novolac, polyphenol which is obtained by reacting salicylaldehyde and phenol or cresol in the presence of an acid catalyst, polyphenol which is obtained by reacting p-hydroxybenzaldehyde and phenol or cresol in the presence of an acid catalyst, and which is obtained by reacting terephtalaldehyde and phenol, cresol, or bromphenol in the presence of an acid catalyst; etc. Among these, a phenol, which is divalent or more is preferable, and in particular, novolac type, paraxylene modified novolac type, methaxylene modified novolac type, orthoxylene modified novolac type, bisphenol type, biphenyl type, resol type, phenolaralkyl type, aralkyl type having a biphenyl skeleton, naphthalene ring containing type, dicyclopenthadiene modified type, etc., are more preferable.

An (iso)phthalate resin, having at least two groups selected from an allyl group and a methallyl group, is not particularly limited and includes an ortho-type resin, an iso-type resin, and a para-type resin, and specifically includes diallylphthalate, diallylisophthalate, diallylterephthalate, di(methylallyl)phthalate, di(methylallyl)isophthalate, di(methylallyl)terephthalate, etc. These resins may each be used independently, or two or more resins may be used in combination.

An (iso)cyanurate resin, having at least two groups selected from an allyl group and a methallyl group, is not also particularly limited and includes an ortho-type resin, an iso-type resin, and a para-type resin, and specifically includes diallylcyanurate, diallylisocyanurate, triallylcyanurate, triallylisocyanurate, di(methylallyl)cyanurate, di(methylallyl)isocyanurate, tri(methyallyl)cyanurate, tri(methylallyl)isocyanurate, etc. These resins may each be used independently, or two or more resins may be used in combination.

In the composition of the present invention, it is preferable that the Tg of the mixture containing the components (B) and (C) be higher than the Tg of the component (A). Specifically, the Tg of the mixture containing the components (B) and (C) may be more preferably higher than the Tg of the component (A) at 30° C. or greater, and most preferably at 50° C. or greater. If the Tg of the mixture containing the components (B) and (C) is lower than the Tg of the component (A), heat resistance of the obtained composition may be insufficient.

In the heat resistant adhesive composition comprising the three-dimensional cross-linking type thermosetting resin, the content of the component (A) is preferably in a range from 15 to 85% by weight relative to 100% by weight of the total solid content in the composition, and more preferably in a range from 20 to 80% by weight. If the content of the component (A) is less than 15% by weight, toughness and ductility (film forming property) may be insufficient; therefore, it is not preferable for the content of the component (A) to be less than 15% by weight. If it exceeds 85% by weight, workability at low temperatures and heat resistance may be insufficient; therefore, it is not preferable for the content of the component (A) to exceed 85% by weight.

The molar equivalent of the functional group in the component (C) relative to 1 molar equivalent of the functional group in the component (B) is preferably in a range from 2.0 to 0.1, and more preferably in a range from 1.5 to 0.1. If the molar equivalent of the functional group in the component (C) relative to 1 molar equivalent of the functional group in the component (B) exceeds 2.0, heat resistant may be insufficient; therefore, it is not preferable for the molar equivalent of the functional group in the component (C) relative to 1 molar equivalent of the functional group in the component (B) to exceed 2.0. If this is less than 0.1, toughness and ductility (film forming property) may be insufficient; therefore, it is not preferable for this to be less than 0.1.

The heat resistant adhesive composition comprising the three-dimensional cross-linking type thermosetting resin may contain additives in accordance with need, as far as the properties of the flexible metallic layered product is not deteriorated.

If a hardening accelerator such as an organic peroxide, and a Lewis acid compound is added to the composition, hardening by heat of the three-dimensional cross-linking type thermosetting resin is facilitated.

In order to make the composition fire retardant, a phosphoric ester compound, an ester compound containing nitrogen, or a halogenated epoxy resin may be added.

In order to control the linear expansion of the composition, an organic filler, an inorganic filler, etc., may be added.

In order to facilitate the reaction during drying or thermal hardening, a reaction facilitating agent is preferably added. In order to improve adhesive strength to metal, a coupling agent is preferably added. In addition, in order to apply a surface smoothness and prevent changing of fluidity and improve heat size stability, a filler is preferably added.

A reaction facilitating agent is not particularly limited, and includes an organic peroxide, amine, imidazole, triphenylsulfone, etc. Among these, an organic peroxide is more preferable, because this has excellent reactivity.

An organic peroxide as a reaction facilitating agent includes diazabicyclooctane, methylethylketone peroxide, cyclohexane peroxide, 3,3,5-trimethylcyclohexanone peroxide, methylcyclohexanone peroxide, methylacetoacetate peroxide, acetylacetone peroxide, 1,1-bis(t-butylperoxy)-3,3,5-trimethylhexane, 1,1-bis(t-butylperoxy)-cyclohexane, 2,2-bis(t-butylperoxy)octane, n-butyl-4,4-bis(t-butylperoxy)barate, 2,2-bis(t-butylperoxy)butane, t-butyl hydroperoxide, cumene hydroperoxide, di-isopropylbenzene hydroperoxide, p-menthane hydroperoxide, 2,5-dimethylhexane-2,5-dihydroperoxide, 1,1,3,3-tetramethylbutyl hydroperoxide, dicumyl peroxide, t-butylcumyl peroxide, di-t-butyl peroxide, α,α′-bis(t-butylperoxy-m-isopropyl)benzene, 2,5-dimethyl-2,5-di(t-butylperoxy)hexane, 2,5-dimethyl-2,5-di(t-butylperoxy)hexine, acetyl peroxide, isobutyl peroxide, octanoyl peroxide, decanoyl peroxide, benozoyl peroxide, lauroyl peroxide, 3,5,5-trimethylhexanoyl peroxide, succinic acid peroxide, 2,4-dichlorobenzoyl peroxide, m-toluoyl peroxide, diisopropylperoxy dicarbonate, di-2-ethylhexylperoxy dicarbonate, di-n-propylperoxy dicarbonate, bis(4-t-butylcyclohexyl)peroxy dicarbonate, di-myristylperoxy dicarbonate, di-2-ethoxyethylperoxy dicarbonate, di-methoxyisopropylperoxy dicarbonate, di(3-methyl-3-methoxybutyl)peroxy dicarbonate, di-allylperoxy dicarbonate, t-butylperoxy acetate, t-butylperoxy isobutylate, t-butylperoxy pivalate, t-butylperoxy neodecanate, cumylperoxy neodecanate, t-butylperoxy-2-ethylhexanate, t-butylperoxy-3,5,5-trimethylhexanate, t-butylperoxylaurate, t-butylperoxybenzoate, di-t-butylperoxyisophtalate, 2,5-dimethy-2,5-di(benzoylperoxy)hexane, t-butylperoxy maleic acid, t-butylperoxyisopropyl carbonate, cumylperoxyoctate, t-hexylperoxyneodecanate, t-hexylperoxy pivalate, t-butylperoxyneohxanate, acetylcyclohexylsulfonyl peroxide, t-butylperoxyallyl carbonate, etc. These organic peroxides may each be used independently, or two or more organic peroxides may be used in combination.

A coupling agent is not particularly limited, and includes a silane coupling agent, a titanium coupling agent, aluminum coupling agent, etc.

A silane coupling agent includes vinyltrimethoxy silane, vinyltriethoxy silane, N-(2-aminoethyl)3-aminopropylmethyldimethoxy silane, N-(2-aminoethyl)3-aminopropylmethyldiethoxy silane, N-(2-aminoethyl)3-aminopropyltrimethoxy silane, N-(2-aminoethyl)3-aminopropyltriethoxy silane, 3-aminopropyltrimethoxy silane, 3-aminopropyltriethoxy silane, 3-glycidoxypropyltrimethoxy silane, 3-glycidoxypropyltriethoxy silane, 3-glycidoxypropylmethyldimethoxy silane, 3-glycidoxypropylmethyldiethoxy silane, 2-(3,4-epoxycyclohexyl)ethyltrimethoxy silane, 3-chloropropylmethyldimethoxy silane, 3-chloropropyltrimethoxy silane, 3-methacryloxypropyltrimethoxy silane, 3-mercaptopropyltrimethoxy silane, N-(1,3-dimethylbutylidene)-3-(triethoxysilyl)-1-propane amine, N-[2-(vinylbenzylamino)ethyl]-3-aminopropyltrimethoxy silane hydrochloride, N,N′-bis[3-(trimethoxysilyl)propyl]ethylene diamine, etc.

A titanium coupling agent includes isopropyltriisostearoyl titanate, isopropyltridodecylbenzenesulfonyl titanate, isopropyltri(dioctylpyrophosphate) titanate, tetraisopropylbis(dioctylphosphite) titanate, tetraoctylbis(ditridecylphosphite) titanate, tetra(2,2-diallyloxymethyl-1-butyl)bis(di-tridecyl)phosphite titanate, bis(dioctylpyrophospate)oxyacetate titanate, bis(dioctylpyrophosphate)ethylene titanate, isopropyltrioctanoyl titanate, isopropyldimethacylisostearoyl titanate, isopropylisostearoyldiacryl titanate, isopropyltri(dioctylphosphate) titanate, isopropyltricumylphenyl titanate, isopropyltri(N-amidoethyl.aminoethyl) titanate, dicumyl phenyloxyacetate titanate, diisostearylethylene titanate, etc.

An aluminum coupling agent includes acetoalkoxyaluminum diisopropylate, etc.

Among these coupling agents, a silane coupling agent is preferably used, because this has excellent adhesive strength improving effects.

A filler is not particularly limited, and includes an inorganic filler and an organic filler. As a filler, an inorganic filler such as silica, a quartz powder, alumina, calcium carbonate, magnesium oxide, a diamond powder, mica, a fluororesin, zircon, etc., is preferably used.

The particle diameter of a filler is not particularly limited, but a filler having an average particle diameter of 5 μm or less is preferably used. If the average particle diameter of a filler exceeds 5 μm, dispersibility of a filler in the resin composition may be deteriorated and film forming property of the compound may be also deteriorated.

The content of a filler is not also particularly limited, but this is preferably in a range from 0.1 to 70% by weight relative to 100% by weight of the total solid content of the heat resistant adhesive composition, more preferably in a range from 0.5 to 60% by weight, and most preferably in a range from 1 to 50% by weight. If the content is less than 0.1% by weight, effects (improving surface smoothness or size stability), which are obtained by adding a filler, are insufficiently obtained, and if this exceeds 70% by weight, toughness and ductility (film forming property) may be insufficient.

A thermoplastic resin in the thermoplastic resin layer 4 is needed to give flexibility to the flexible metallic layered product, specifically, to give sufficient bendability and tensile strength for transferring the flexible metallic layered product. A thermoplastic resin in the thermoplastic resin layer 4 is not particularly limited, and includes any material which can be practically used for a flexible printed circuit board (FPC). Specifically a thermoplastic resin in the thermoplastic resin layer 4 includes a polyester resin such as polyethylene terephthalate, polyethylene naphthalate, etc., and a thermoplastic liquid crystal resin such as thermotropic liquid crystal polyester resin, thermotropic liquid crystal ester amide resin, etc. Among these, when heat resistance is considered, a heat resistant thermoplastic resin such as polyimide resin, polyamide imide resin, polyether imide resin, polysiloxane imide resin, polyether ketone resin, polyether ether ketone resin, etc., is preferable. In addition, among these, a thermoplastic resin, which is at least one of polyimide resin, polyamide imide resin, polyether imide resin, polysiloxane imide resin, polyether ketone resin, polyether ether ketone resin, and which is dissolved in a solvent and in which a dehydration-condensation reaction such as an imide reaction is fully completed.

In the present invention, the ratio (t1/t2) between the thickness (t1) of the three-dimensional cross-linking type thermosetting resin layer 3 and the thickness (t2) of the entirety of resin layers on the metallic layer 2 is preferably in a range from 7/100 to 85/100, more preferably in a range from 10/100 to 70/100, and most preferably in a range from 25/100 to 50/100. If the ratio (t1/t2) is less than 7/100, heat resistance of the three-dimensional cross-linking type thermosetting resin layer 3, which is layered onto the metallic layer 2, may deteriorate, and heat resistance of the entirety of resin layers on the metallic layer 2 may also deteriorate. If the ratio (t1/t2) exceeds 85/100, mechanical properties such as bendability and tensile strength of the flexible metallic layered product may easily deteriorate.

Moreover, the thickness (t2) of the entirety of resin layers is measured using a micrometer, etc., after the metallic layer 2 is removed by using an etchant and only resin layers remain. The thickness (t1) of the three-dimensional cross-linking type thermosetting resin layer 3 is measured with a micrometer, etc., by using the layered product comprising only the resin layers, and removing resin layers besides the three-dimensional cross-linking type thermosetting resin layer 3 by a solvent.

In the present invention, the three-dimensional cross-linking type thermosetting resin layer 3 has preferably the glass transition point (Tg) and the thermal decomposition starting temperature, which are higher than those of the thermoplastic resin layer 4. In addition, the three-dimensional cross-linking type thermosetting resin layer 3 has also preferably storage elastic modulus (E′) and loss elastic modulus (E″), which are larger than those of the thermoplastic resin layer 4. Specifically, the glass transition point (Tg) of the three-dimensional cross-linking type thermosetting resin layer 3 is preferably higher than the glass transition point (Tg) of the thermoplastic resin layer 4 at 20° C. or greater. Due to this, since heat resistance of the three-dimensional cross-linking type thermosetting resin layer 3 is superior to heat resistance of the thermoplastic resin layer 4, even when heat is applied to the surface of the resin layer, the surface of the resin layers does not readily melt and flow, and thereby deformation of the resin layers is prevented. In other words, heat resistance of the entirety of the resin layers on the metallic layer 2 is improved by laminating the three-dimensional cross-linking type thermosetting resin layer 3, which does not readily melt and flow, that is, of which the surface does not readily deform, on the metallic layer 2 and laminating the thermoplastic resin layer 4, which readily melt and flow, that is, of which the surface readily deforms, on the three-dimensional cross-linking type thermosetting resin layer 3. Therefore, if the flexible metallic layered product is subjected to high-temperature and high pressure during mounting in a flip chip bonding method, specifically, when electrodes of an IC chip and a conductor, which is the metallic layer 2 of the flexible metallic layered product, are bonded, deformation and melting of the resin layers is prevented, because heat resistance of the three-dimensional cross-linking type thermosetting resin layer 3 contacting the metallic layer 2 is improved.

In contrast, in a flexible metallic layered product in which the thermoplastic resin layer 4 is layered on the metallic layer 2, and then the three-dimensional cross-linking type thermosetting resin layer 3 having excellent heat resistance is layered on the thermoplastic resin layer 4, since heat resistance of the thermoplastic resin layer 4 contacting to the metallic layer 2 is low, it is impossible to improve heat resistance of the entirety of the resin layers.

In the present invention, in order to improve properties of the flexible metallic layered product, one or more organic resin layers may be layered on the thermoplastic resin layer 4, in accordance with need. An organic resin layer includes the three-dimensional cross-linking type thermosetting resin layer. Heat resistance of the flexible metallic layered product is improved by layering the three-dimensional cross-linking type thermosetting resin layer on the thermoplastic resin layer 4.

In order to easily transfer the semiconductor flexible printed circuit board comprising the flexible metallic layered product during its production, 0.1 to 3 parts by weight of an inorganic filler relative to 100 parts by weight of the composition comprising an outermost resin layer may be added in the outermost resin layer, which is the farthest from the metallic layer 2. It is preferable that colloidal silica, silicon nitride, talc, titanium oxide, calcium phosphate, etc., which have an average particle diameter in a range from 0.005 to 5 μm, and more preferably in a range from 0.005 to 2 μm.

Below, the production method of the flexible metallic layered product of the present invention will be explained.

The lamination method for the three-dimensional cross-linking type thermosetting resin layer 3 and the thermoplastic resin layer 4 is not particularly limited. However, for example, the three-dimensional cross-linking thermosetting resin, which is dissolved in a solvent, is coated on the metallic layer 2 such as a metallic foil, and then the solvent is dried, and after heating, the resin thereby is cured, the thermoplastic resin, which is melted, is laminated on the three-dimensional cross-linking type thermosetting resin layer using an extruder. When the three-dimensional cross-linking thermosetting resin layer is heated and melted, thermosetting reaction is facilitated during melting, and before lamination on the metallic layer, the three-dimensional cross-linking thermosetting resin may start to harden and an extrusion molding may be difficult. Therefore, it is preferable that the three-dimensional cross-linking thermosetting resin be dissolved in a solvent and coated on the copper foil, and then the solvent be removed.

The temperature of the heat treatment for hardening the three-dimensional cross-linking thermosetting resin is not particularly limited, but this is preferably in a range from 200 to 350° C., and more preferably in a range from 230 to 350° C. In addition, an atmosphere in a heat treatment is preferably changed to an inert gas such as nitrogen, etc.

In order to prevent the delamination between the three-dimensional cross-linking thermosetting resin layer and the thermoplastic resin layer, it is preferable that the three-dimensional cross-linking thermosetting resin, which is dissolved in a solvent, be coated on one surface of the metallic layer 2, and that the solvent be removed, then the thermoplastic resin layer be laminated on the three-dimensional cross-linking thermosetting resin layer, and then thermosetting resin in the three-dimensional cross-linking thermosetting resin layer be hardened.

In the production method, the thermoplastic resin layer is laminated using an extruder, but the thermoplastic resin, which is dissolved in a solvent, may be coated.

When the three-dimensional cross-linking thermosetting resin and the thermoplastic resin are dissolved in a solvent and laminated, the solvent use may be any solvent as long as this dissolves each resin. The solvent may be used independently, or two or more solvents may be used in combination. The solvent includes a pyrolidone solvent such as N-methyl-2-pyrolidone, N-vinyl-2-pyrolidone, an acetamide solvent such as N,N-dimethylacetamide, N,N-diethylacetamide, a formamide solvent such as N,N-dimethylformamide, N,N-diethylformamide, a sulfoxide solvent such as dimethysulfoxide, diethylsulfoxide, etc. As long as solubility of coating resin is not influenced, a ketone solvent such as acetone, methyl ethyl ketone, cyclopentanone, cyclohexanone, an aromatic compound solvent such as toluene, and xylene, an ether solvent such as tetrahydrofurane, dioxane, diglyme, triglyme, etc., may be used together with the above-mentioned solvents having a relative high boiling point.

When the three-dimensional cross-linking type thermosetting resin layer contains the components (A) to (C), the solvent used is not particularly limited, and this includes commercially available solvents. However, a non-protonic solvent, which dissolves the component (A), is preferably used. Specifically, the solvent includes dimethy formamide, dimethyl acetamide, N-methy-2-pyrrolidone, dimethyl sulfoxide, nitrobenzene, glycol carbonate, etc. In addition, it is also preferable to use a solvent, which dissolves the components (B) and (C) and which is compatible with a non-protonic solvent, together with a non-protonic solvent. A solvent, which dissolves the components (B) and (C), includes an aromatic solvent such as benzene, toluene, and xylene, a ketone compound such as acetone, and methyl ethyl ketone, an ether compound such as tetrahydrofurane, dioxane, 1,2-dimethoxyethane, polyethylene glycol dimethyl ether, etc. These solvents are preferably used.

When the three-dimensional cross-linking type thermosetting resin and the thermoplastic resin are dissolved in an organic solvent and coated, a coating machine is not particularly limited, and any coating machine can be used as long as this can coat the resin in accordance with a desired layer thickness. The coating machine includes a dam coater, a reverse coater, a lip coater, a micro gravure coater, a comma coater, etc. When these resins are melted by heat and coated, an extrusion molding method is applied. An extrusion molding method includes a T-die molding, a lamination drawing molding, an inflation molding, etc.

The heat resistant adhesive composition of the present invention is used for attaching or covering a part, which has to resist heat. The heat resistant adhesive composition of the present invention is preferably used for producing electronic equipment, which has to resist heat, and in particular, is preferably used for producing a semiconductor integrated circuit comprising an insulating layer and a semiconductor circuit.

Below, the flexible metallic layered product of the present invention will be explained in detailed with reference to examples and comparative examples. However, the present invention is not limited to the following examples.

### PREPARATION EXAMPLES 1 TO 7 OF THE THREE-DIMENSIONAL CROSS-LINKING TYPE THERMOSETTING RESIN COMPOSITION

A soluble polyamide imide resin (marketed by TOYOBO Co., Ltd.; trade name: VYLOMAX® HR16NN; Tg: 330° C.), which is the component (A), was dissolved in N-methyl-2-pyrrolidone (NMP) so that the solid content be 14% by weight, and thereby a solution (1) was obtained. Bismaleimide resin (marketed by K•I Chemical Industry Co., LTD.; trade name: BMI-70), which is the component (B), was dissolved in NMP so that the solid content be 40% by weight, and thereby a solution (2) was obtained. Allylphenol resin (marketed by MEIWA PLASTIC INDUSTRIES, LTD; trade name: MEH-8000H), which is the component (C), was dissolved in NMP so that the solid content be 40% by weight, and thereby a solution (3) was obtained. Then, the obtained solutions (1) to (3) were mixed at solid content mixing ratios (weight ratios) in Table 1, and thereby the three-dimensional cross-linking type thermosetting resin compositions 1 to 7 were prepared.

### PREPARATION EXAMPLE 8 OF THE THREE-DIMENSIONAL CROSS-LINKING TYPE THERMOSETTING RESIN COMPOSITION

A soluble polyimide resin (Tg: 160° C.), which is the component (A), was prepared in a production method disclosed in Japanese Unexamined Patent Application, First Publication No. H12-063788, Synthetic Example 2, then this was dissolved in NMP so that the solid content be 14% by weight, and thereby the three-dimensional cross-linking type thermosetting resin composition 8 was prepared.

### PREPARATION EXAMPLE 9 OF THE THREE-DIMENSIONAL CROSS-LINKING TYPE THERMOSETTING RESIN COMPOSITION

A soluble polyamide imide resin (marketed by TOYOBO Co., Ltd.; trade name: VYLOMAX® HR16NN; Tg: 330° C.), which is the component (A), was dissolved in N-methyl-2-pyrrolidone (NMP) so that the solid content be 14% by weight, and thereby a solution (1) was obtained. Bismaleimide resin (marketed by K•I Chemical Industry Co., LTD.; trade name: BMI-70), which is the component (B), was dissolved in NMP so that the solid content be 40% by weight, and thereby a solution (2) was obtained. Then, the obtained solutions (1) and (2) were mixed at a solid content mixing ratio (weight ratio) in Table 1, and thereby the three-dimensional cross-linking type thermosetting resin composition 9 was prepared.

The solid content mixing ratios of the three-dimensional cross-linking type thermosetting resin compositions 1 to 9 are shown in the following Table 1. In Table 1, the molar equivalents of the functional group in the component (C) relative to 1 molar equivalent of the functional group in the component (B) are also shown.

TABLE 1

| | | Three-dimensional cross-linking type | | | | | | | | |
|---|---|---|---|---|---|---|---|---|---|---|
| | | thermosetting resin composition | | | | | | | | |
| | | 1 | 2 | 3 | 4 | 5 | 6 | 7 | 8 | 9 |
| Composition | Component(A): Polyamide imide resin | 15.0 | 35.0 | 50.0 | 65.0 | 85.0 | 10.0 | 90.0 | | 50.0 |
| | Component(A): Polyimide resin | | | | | | | | 100.0 | |
| | Component(B): Bismaleimide resin | 74.0 | 56.6 | 43.5 | 30.5 | 11.3 | 78.3 | 8.7 | | 50.0 |
| | Component (C): Allylphenol resin | 11.0 | 8.4 | 6.5 | 4.5 | 3.7 | 11.7 | 1.3 | | |

| | | | | | | | |
|---|---|---|---|---|---|---|---|
| Molar equivalents of the functional group in the | 0.23 | 0.23 | 0.23 | 0.23 | 0.23 | 0.23 | 0.23 |
| component (C) relative to 1 molar equivalent of the | | | | | | | |
| functional group in the component (B) | | | | | | | |

Production of the Three-Dimensional Cross-Linking Type Thermosetting Resin Layer

After coating the obtained three-dimensional cross-linking type thermosetting resin compositions 1 to 9 on the matte side of an electrolytic copper foil having a thickness of 12 μm (marketed by Mitsui Mining and Smelting Co., Ltd.; trade name: TQ-VLP), they were heated and dried at 150° C. for 10 minutes, and thereby they were hardened to a B-stage; after that, they were heated at 300° C. for 3 hours in a nitrogen atmosphere and the resin was completely hardened, and thereby the three-dimensional cross-linking type thermosetting resin layers 1 to 9 having a thickness of 20 μm were prepared.

The prepared three-dimensional cross-linking type thermosetting resin layers 1 to 9 were evaluated as follows. The results are shown in the following Table 2.

1. Dynamic Modulus of Elasticity and Tg of the Adhesive Resin Composition after Hardening

Only the three-dimensional cross-linking type thermosetting resin layers were obtained by etching and removing the metallic foils from the prepared three-dimensional cross-linking type thermosetting resin layers 1 to 9 by a subtractive method. The dynamic modulus of elasticity of the obtained three-dimensional cross-linking type thermosetting resin layers at 300° C. and 350° C. was measured using a forced oscillation non-resonance type viscoelasticity measuring device (marketed by Orientec Co., Ltd.; trade name: RHEOVIBRON®) under the following conditions. Tg was calculated from the top peak of tan δ in the obtained measuring results.

### MEASURING CONDITIONS

Excitation frequency: 11 Hz
Static tension: 3.0 gf
Sample size: 0.5 mm (width)×30 mm (length)
Programming rate: 3° C./min
Atmosphere: Air
   2. Adhesive Strength

Copper patterns having a width of 5 mm were formed by etching the metallic foils of the three-dimensional cross-linking type thermosetting resin layers 1 to 9 by a subtractive method. Peeling strength, in the case that the three-dimensional cross-linking type thermosetting resin layer was peeled from the copper patterns, was measured as an adhesive strength.

### MEASURING CONDITIONS

Peeling speed: 50 mm/min
Peeling angle: 90°
   3. Heat Resistance

Circuits for a flip chip bonding were formed by etching the metallic layers in the three-dimensional cross-linking type thermosetting resin layers 1 to 9 by a subtractive method. After that, the formed circuits were flip chip bonded using a flip chip bonder (marketed by SHIBUYA KOGYO CO., LTD.; trade name: DB200) under condition, in which the temperature and the relative humidity had been controlled 23° C. and 55% for 72 hours, and under the following bonding conditions. The appearance and the section of the bonded part of the three-dimensional cross-linking type thermosetting resin layers 1 to 9 were observed and evaluation was conducted based on the following standards.

### BONDING CONDITIONS

Highest temperature: 400° C.
Keeping time at the highest temperature: 2.5 seconds
Load applied: 200 N/cm²

### EVALUATION STANDARDS

Good: Changes at the appearance of the adhesive layer are not observed and deformation and peeling are also not observed in the bonding part.
Fair: Some changes at the appearance of the adhesive layer are observed or some deformations and peelings are observed in the bonding part.
Bad: Changes at the appearance of the adhesive layer are clearly observed and remarkable deformations and peelings are observed in the bonding part.
   4. Film Forming Property

Only the three-dimensional cross-linking type thermosetting resin layers were obtained by etching and removing the metallic foils from the prepared three-dimensional cross-linking type thermosetting resin layers 1 to 9 by a subtractive method. Film forming property was evaluated based on the following evaluation standards by observing the obtained layers.

### EVALUATION STANDARDS

Good: The resin layer can be layered again and it maintains a film form after removing the metallic foil.
Fair: The resin layer can be layered again but breakage or cracking easily ocurs.

Bad: The resin layer can be layered again but this cannot maintain a foil form after removing the metallic foil.

TABLE 2

| | | Three-dimensional cross-linking type thermosetting resin layers | | | | | | | | |
|---|---|---|---|---|---|---|---|---|---|---|
| | | 1 | 2 | 3 | 4 | 5 | 6 | 7 | 8 | 9 |
| Tg (° C.) after hardening | | 355 | 350 | 345 | 340 | 340 | 360 | 340 | 160 | 335 |
| Adhesive strength (kN/cm) | | 0.55 | 0.65 | 0.86 | 1.00 | 1.00 | 0.45 | 1.05 | 0.30 | 0.50 |
| Dynamic modulus of | 300° C. | 1.08 | 1.25 | 1.28 | 1.28 | 1.28 | 1.28 | 1.28 | 0.001 or less | 1.18 |
| elasticity (GPa) | 350° C. | 0.62 | 0.68 | 0.67 | 0.61 | 0.55 | 0.86 | 0.25 | 0.001 or less | 0.43 |

| | | | | | | | | | |
|---|---|---|---|---|---|---|---|---|---|
| Heat resistance | Good | Good | Good | Good | Good | Good | Fair | Bad | Bad |
| Film forming property | Good | Good | Good | Good | Good | Fair | Good | Good | Bad |

As shown in Table 2, when the three-dimensional cross-linking type thermosetting resin compositions 1 to 5, which comprises the thermoplastic resin (A) having at least one imide group, the thermosetting compound (B) having at least two maleimide groups, and the compound (C) having a functional group, which is reactive to the thermosetting compound (B), and in which the content of the component (A) is in a range from 15 to 85% by weight relative to 100% by weight of the total solid content of the three-dimensional cross-linking type thermosetting resin compositions, were used, a film was easily formed on the copper foil at relative low temperature with no problems. Tg of the compositions after hardening was high such as 340 to 350° C., and the three-dimensional cross-linking type thermosetting resin layers having high heat resistance were prepared. Thereby, a flip chip bonding was conducted at temperatures exceeding Tg of the composition after hardening without problems. In addition, since the three-dimensional cross-linking type thermosetting resin layers maintained high dynamic modulus of elasticity at high temperatures exceeding Tg of the component (A), the compositions after hardening have sufficient mechanical strength and high pressure tightness at high temperatures. Compared with the three-dimensional cross-linking type thermosetting resin composition 8 comprising only the thermoplastic resin (A), these compositions had superior adhesive strength to the copper foil.

Although the three-dimensional cross-linking type thermosetting resin composition 6 comprises the components (A) to (C), this comprises less than 1.5% by weight of the component (A) relative to 100% by weight of the total solid content. Therefore, although the three-dimensional cross-linking type thermosetting resin composition 6 has heat resistance, workability, and mechanical strength (modulus of elasticity), which are substantially equal those of the three-dimensional cross-linking type thermosetting resin compositions 1 to 5, this has slight inferior adhesive strength and film forming property. However, adhesive strength and film forming property of the three-dimensional cross-linking type thermosetting resin composition 6 do not cause serious practical consequences.

Although the three-dimensional cross-linking type thermosetting resin composition 7 comprises the components (A) to (C), this comprises more than 85% by weight of the component (A) relative to 100% by weight of the total solid content. Therefore, although the three-dimensional cross-linking type thermosetting resin composition 7 has film forming property, workability, and mechanical strength (modulus of elasticity), which are substantially equal those of the three-dimensional cross-linking type thermosetting resin compositions 1 to 5, slight deformation was observed in a circuit of the flip chip bonded part and the adhesive layer. Compared with the three-dimensional cross-linking type thermosetting resin compositions 1 to 5, the three-dimensional cross-linking type thermosetting resin composition 7 has slightly inferior heat resistance. However, heat resistance of the three-dimensional cross-linking type thermosetting resin composition 6 does not cause serious practical consequences.

Consequently, it is clear that in particular, it is preferable for the composition to contain the components (A) to (C) and for the content of the component (A) relative to 100% by weight of the total solid content to be in a range from 15 to 85% by weight.

### PREPARATION EXAMPLE 10 OF THE THREE-DIMENSIONAL CROSS-LINKING TYPE THERMOSETTING RESIN COMPOSITION

The following polyimide resin solution and bisallylnadimide resin solution were mixed so as to have the solid content (weight ratio) shown in Table 3, and thereby the three-dimensional cross-linking type thermosetting resin composition 10 for the three-dimensional cross-linking type thermosetting resin layer.

Polyimide Resin Solution

10.33 g (52 mmole) of 3,4′-diaminodiphenylether, 18.23 g (48 mmole) of 1,3-bis(3-aminophenoxymethyl)-1,1,3,3-tetramethyldisiloxane, 32.22 g (100 mmole) of 3,4,3′,4′-benzophenone tetracarboxylic dehydrate, and 300 ml of N-methyl-2-pyrrolidone (NMP) were added into a flask having an agitator at a temperature less than an ice temperature, and stirred for 1 hour. Then, the obtained solution was reacted at room temperature for 3 hours under a nitrogen atmosphere, and polyamic acid was synthesized. 50 ml of toluene and 1.0 g of p-toluene sulfonic acid were added to the synthesized polyamic acid and then they were heated to 160° C. Then, the reaction was maintained for 3 hours to obtain an imide compound, while water, which was azeotrope with toluene, was removed. After removing toluene, the obtained polyimide varnish was poured in methanol, the obtained precipitate was removed. The removed precipitate was crushed, washed, and dried, and then polyimide resin having a glass transition point of 180° C. was obtained. After that, a polyimide resin solution was prepared by dissolving the obtained polyimide resin in tetrahydrofuran so as to have a solid content of 25% by weight.

Bisallylnadimide Resin Solution

A bisallylnadimide resin solution was obtained by dissolving bisallyladimide resin (marketed by Maruzen Petrochemical CO., LTD.; trade name: BAMI-M) in tetrahydrofuran so as to have the solid content of 50% by weight.

### PREPARATION EXAMPLE 11 OF THE THREE-DIMENSIONAL CROSS-LINKING TYPE THERMOSETTING RESIN COMPOSITION

The following polyamide imide resin solution, bisallylnadimide resin solution, and allyl phenol resin solution were mixed so as to have the solid content (weight ratio) shown in Table 3, and thereby the three-dimensional cross-linking type thermosetting resin composition 10 for the three-dimensional cross-linking type thermosetting resin layer was obtained.

Polyamide Imide Resin Solution

The polyamide imide resin solution was obtained by dissolving polyamide imide resin (marketed by TOYOBO Co., Ltd.; trade name: VYLOMAX® HR16NN; Tg: 330° C.) in N-methyl-2-pyrrolidone (NMP) so as to have the solid content of 14% by weight.

Bismaleimide Resin Solution

A bismaleimide resin solution was obtained by dissolving bismaleimide resin (marketed by K•I Chemical Industry Co., LTD.; trade name: BMI-70) in N-methyl-2-pyrrolidone (NMP) so as to have the solid content of 40% by weight.

Allyl Phenol Resin Solution

An allyl phenol resin solution was obtained by dissolving allylphenol resin (marketed by MEIWA PLASTIC INDUSTRIES, LTD; trade name: MEH-8000H) in N-methyl-2-pyrrolidone (NMP) so as to have the solid content of 40% by weight.

The compositions of the three-dimensional cross-linking type thermosetting resin compositions 10 and 11 are shown in the following Table 3.

TABLE 3

| | Three-dimensional | Three-dimensional |
|---|---|---|
| | cross-linking type | cross-linking type |
| | thermosetting resin | thermosetting resin |
| | composition 10 | composition 11 |
| Polyimide resin | 25.0 | |
| Polyamide imide resin | | 35.0 |
| Bisallylnadimide resin | 75.0 | |
| Bismaleimide resin | | 56.6 |
| Allyl phenol resin | | 8.4 |

### PREPARATION EXAMPLE 1 OF THE RESIN COMPOSITION FOR THERMOPLASTIC RESIN LAYER

A polyimide resin solution, which was used in the three-dimensional cross-linking type thermosetting resin composition 10, was used as the thermoplastic resin composition 1 for the thermoplastic resin layer.

### PREPARATION EXAMPLE 2 OF THE COMPOSITION FOR THERMOPLASTIC RESIN LAYER

A polyamide imide resin solution, which was used in the three-dimensional cross-linking type thermosetting resin composition 11, was used as the thermoplastic resin composition 2 for the thermoplastic resin layer.

Then, the flexible metallic layered products were produced using these compositions for the thermoplastic resin layer and the three-dimensional cross-linking type thermosetting resin layer.

### EXAMPLE 1

The three-dimensional cross-linking type thermosetting resin composition 10 was coated on the matte side of the electrolytic copper foil (marketed by Mitsui Mining and Smelting Co., Ltd.; trade name: TQ-VLP; thickness: 12 μm) so as to have a thickness of 7 μm after drying, and the composition was dried at 100° C. for 5 minutes, and thereby the three-dimensional cross-linking type thermosetting resin layer was produced. After that, the resin composition 1 for the thermoplastic resin layer was coated on the surface of the produced three-dimensional cross-linking type thermosetting resin layer so as to have a thickness of 25 μm after drying, and the composition was dried at 100° C. for 10 minutes, and thereby the thermoplastic layer was produced. Next, the three-dimensional cross-linking type thermosetting resin composition 10 was coated on the surface of the produced thermoplastic resin layer so as to have a thickness of 8 μm after drying, and the composition was dried at 100° C. for 5 minutes, and thereby the organic resin layer was produced. The flexible metallic layered product having a total thickness of the resin layers of 40 μm of the present invention was produced by treating by heat the layered product under a nitrogen atmosphere while maintaining temperature at 70° C. for 4 hours, raising the temperature from 70° C. to 250° C. for 10 hours, and maintaining at 250° C. for 3 hours.

### EXAMPLE 2

The three-dimensional cross-linking type thermosetting resin composition 10 was coated on the matte side the electrolytic copper foil (marketed by Mitsui Mining and Smelting Co., Ltd.; trade name: TQ-VLP; thickness: 12 μm) so as to have a thickness of 3 μm after drying, and the composition was dried at 100° C. for 5 minutes, and thereby the three-dimensional cross-linking type thermosetting resin layer was produced. After that, the resin composition 1 for the thermoplastic resin layer was coated on the surface of the produced three-dimensional cross-linking type thermosetting resin layer so as to have a thickness of 30 μm after drying, and the composition was dried at 100° C. for 10 minutes, and thereby the thermoplastic layer was produced. Next, the three-dimensional cross-linking type thermosetting resin composition 10 was coated on the surface of the produced thermoplastic resin layer so as to have a thickness of 7 μm after drying, and the composition was dried at 100° C. for 5 minutes, and thereby the organic resin layer was produced. The flexible metallic layered product having a total thickness of the resin layers of 40 μm of the present invention was produced by treating by heat the layered product under a nitrogen atmosphere while maintaining the temperature at 70° C. for 4 hours, raising the temperature from 70° C. to 250° C. for 10 hours, and maintaining at 250° C. for 3 hours.

### EXAMPLE 3

The three-dimensional cross-linking type thermosetting resin composition 11 was coated on the matte side of the electrolytic copper foil (marketed by Mitsui Mining and Smelting Co., Ltd.; trade name: TQ-VLP; thickness: 12 μm) so as to have a thickness of 15 μm after drying, and the composition was dried at 150° C. for 5 minutes, and thereby the three-dimensional cross-linking type thermosetting resin layer was produced. After that, the resin composition 2 for the thermoplastic resin layer was coated on the surface of the produced three-dimensional cross-linking type thermosetting resin layer so as to have a thickness of 25 μm after drying, and the composition was dried at 150° C. for 10 minutes, and thereby the thermoplastic layer was produced. The flexible metallic layered product having a total thickness of the resin layers of 40 μm of the present invention was produced by treating by heat the layered product under a nitrogen atmosphere while raising the temperature from 30° C. to 200° C. for 10 hours, maintaining at 200° C. for 1 hour, raising the temperature from 200° C. to 300° C. for 5 hours, and maintaining at 300° C. for 1 hour.

### EXAMPLE 4

A cycle comprising coating of the three-dimensional cross-linking type thermosetting resin composition 11 on the matte side of the electrolytic copper foil (marketed by Mitsui Mining and Smelting Co., Ltd.; trade name: TQ-VLP; thickness: 12 μm) and heating and drying at 150° C. for 5 minutes were repeated three times so as to have a thickness of 30 μm after drying, and thereby the three-dimensional cross-linking type thermosetting resin layer was produced. After that, the resin composition 2 for the thermoplastic resin layer was coated on the surface of the produced three-dimensional cross-linking type thermosetting resin layer so as to have a thickness of 10 μm after drying, and the composition was dried at 150° C. for 5 minutes, and thereby the thermoplastic layer was produced. The flexible metallic layered product having a total thickness of the resin layers of 40 μm of the present invention was produced by treating by heat the layered product under a nitrogen atmosphere while raising the temperature from 30° C. to 200° C. for 10 hours, maintaining at 200° C. for 1 hour, raising the temperature from 200° C. to 300° C. for 5 hours, and maintaining at 300° C. for 1 hour.

### COMPARATIVE EXAMPLE 1

The three-dimensional cross-linking type thermosetting resin composition 10 was coated on the matte side of the electrolytic copper foil (marketed by Mitsui Mining and Smelting Co., Ltd.; trade name: TQ-VLP; thickness: 12 μm) so as to have a thickness of 40 μm after drying, and the resin composition was heated and dried at 100° C. for 10 minutes, and thereby the three-dimensional cross-linking type thermosetting resin layer was produced. Then, the comparative flexible metallic layered product having a total thickness of the resin layers of 40 μm was produced by treating by heat the layered product under a nitrogen atmosphere while maintaining temperature at 70° C. for 4 hours, raising the temperature from 70° C. to 250° C. for 10 hours, and maintaining at 250° C. for 3 hours.

### COMPARATIVE EXAMPLE 2

The resin composition 1 for the thermoplastic resin layer was coated on the matte side of the electrolytic copper foil (marketed by Mitsui Mining and Smelting Co., Ltd.; trade name: TQ-VLP; thickness: 12 μm) so as to have a thickness of 40 μm after drying, and the resin composition was heated and dried at 100° C. for 10 minutes, and thereby the thermoplastic resin layer was produced. Then, the comparative flexible metallic layered product having a total thickness of the resin layers of 40 μm was produced by treating by heat the layered product under a nitrogen atmosphere while maintaining temperature at 70° C. for 4 hours, raising the temperature from 70° C. to 250° C. for 10 hours, and maintaining at 250° C. for 3 hours.

### COMPARATIVE EXAMPLE 3

A cycle comprising coating of the three-dimensional cross-linking type thermosetting resin composition 11 on the matte side of the electrolytic copper foil (marketed by Mitsui Mining and Smelting Co., Ltd.; trade name: TQ-VLP; thickness: 12 μm) and heating and drying at 150° C. for 5 minutes was repeated four times so as to have a thickness of 40 μm after drying, and thereby the three-dimensional cross-linking type thermosetting resin layer was produced. Then, the comparative flexible metallic layered product having a total thickness of the resin layers of 40 μm was produced by treating by heat the layered product under a nitrogen atmosphere while raising the temperature from 30° C. to 200° C. for 10 hours, maintaining temperature at 200° C. for 1 hour, raising the temperature from 200° C. to 300° C. for 5 hours, and maintaining at 300° C. for 1 hour.

### COMPARATIVE EXAMPLE 4

A cycle comprising coating of the resin composition 2 for the thermoplastic resin layer on the matte side of the electrolytic copper foil (marketed by Mitsui Mining and Smelting Co., Ltd.; trade name: TQ-VLP; thickness: 12 μm) and heating and drying at 150° C. for 5 minutes was repeated two times so as to have a thickness of 40 μm after drying, and thereby the thermoplastic resin layer was produced. Then, the comparative flexible metallic layered product having a total thickness of the resin layers of 40 μm was produced by treating by heat the layered product under a nitrogen atmosphere while raising the temperature from 30° C. to 200° C. for 10 hours, maintaining at 200° C. for 1 hour, raising the temperature from 200° C. to 300° C. for 5 hours, and maintaining at 300° C. for 1 hour.

### COMPARATIVE EXAMPLE 5

The resin composition 2 for the thermoplastic resin layer was coated on the matte side of the electrolytic copper foil (marketed by Mitsui Mining and Smelting Co., Ltd.; trade name: TQ-VLP; thickness: 12 μm) so as to have a thickness of 25 μm after drying and heated and dried at 150° C. for 10 minutes, and thereby the thermoplastic resin layer was produced. After that the three-dimensional cross-linking type thermosetting resin composition 11 was coated on the surface of the produced thermoplastic resin layer so as to have a thickness of 15 μm after drying, and the composition was dried at 150° C. for 10 minutes, and thereby the three-dimensional cross-linking type thermosetting resin layer was produced. The comparative flexible metallic layered product having a total thickness of the resin layers of 40 μm was produced by treating by heat the layered product under a nitrogen atmosphere while raising the temperature from 30° C. to 200° C. for 10 hours, maintaining at 200° C. for 1 hour, raising the temperature from 200° C. to 300° C. for 5 hours, and maintaining at 300° C. for 1 hour.

Next, measuring properties and evaluation of the flexible metallic layered products were performed as follows.

1. Glass Transition Point of the Resin Layer

Only the resin layers were obtained by etching and removing the metallic foil from the prepared comparative flexible metallic layered product in the Comparative Examples 1 to 4 by a subtractive method. The storage elastic modulus (E′) of the obtained resin layers was measured using a forced oscillation non-resonance type viscoelasticity measuring device (marketed by Orientec Co., Ltd.; trade name: RHEOVIBRON®) under the following conditions. Tg was calculated from the top peak of tan δ in the obtained measuring results. The results are shown in the following Table 4.

### MEASURING CONDITIONS

Excitation frequency: 11 Hz
Static tension: 3.0 gf
Sample size: 0.5 mm (width)×30 mm (length)
Programming rate: 3° C./min
Atmosphere: Air
   2. Heat Resistance of the Surface of the Resin Layers

After removing the metallic layer from the flexible metallic layered product of the Examples 1 to 4 and the Comparative Examples 1 to 5 by a subtractive method, the remaining resin layers were allowed to stand at 23° C., 55% Rh, for 72 hours. Then, a heated body, which is a soldering iron and has the heated surface having a setting temperature shown below, was contacted with the surface of the resin layer, which had been contacting the metallic layer, for 5 seconds, and heat resistance of the surface layer of the resin layers was evaluated based on the following evaluation standards. The results are shown in the following Table 4. Moreover, the following setting temperature was a temperature, which the glass transition point of the thermoplastic resin layer comprising the flexible metallic layered product plus 70° C. When the flexible metallic layered product does not comprise the thermoplastic resin layer, the setting temperature was adjusted to 400° C.
Bonding temperature: 250° C. (in the Examples 1 and 2, and the Comparative Example 2)
Bonding temperature: 400° C. (in the Examples 3 and 4, and the Comparative Examples 1, and 3 to 5)

### EVALUATION STANDARDS

Good: Deformation due to melting and flowing is not observed at the contacting area with the heated body.
Bad: Serious deformation due to melting and flowing is observed at the contacting area with the heated body.
   3. Flip Chip Bonding Property

A circuit pattern for flip chip bonding was formed on the metallic layer of the flexible metallic layered product in the Examples 1 to 4 and the Comparative Examples 1 to 5 by a photoresist method comprising the steps of coating a photoresist, exposing in a pattern, developing, etching, coating a solder resist, and plating tin. The prepared flexible metallic layered product comprising the circuit pattern was allowed to stand at 23° C., 55% Rh, for 72 hours. Then, the circuit pattern for flip chip bonding and gold bumps of the IC were bonded using a flip chip bonder (marketed by SHIBUYA KOGYO CO., LTD.). After that, changing at the appearance of the resin layer and the section of the bonded part were evaluated based on the following evaluation standards. The results are shown in the following Table 4. Moreover, the following setting temperature was a temperature, which the glass transition point of the thermoplastic resin layer comprising the flexible metallic layered product plus 70° C. When the flexible metallic layered product does not comprise the thermoplastic resin layer, the setting temperature was adjusted to 400° C. The bonding time and bonding pressure were as follows.
Surface temperature of the heated body: 250° C. (in the Examples 1 and 2, and the Comparative Example 2)
Surface temperature of the heated body: 400° C. (in the Examples 3 and 4, and the Comparative Examples 1, and 3 to 5)
Bonding time: 2.5 seconds
Bonding pressure: 200 N/cm²

### EVALUATION STANDARDS

Excellent: Problems are not caused on the appearance and serious deformation and peeling are not generated in the bonding part.
Good: Problems are not caused on the appearance but slight deformation is generated and peeling is not generated in the bonding part.
Fair: Problems are caused on the appearance and deformation and peeling are generated in the bonding part.

Bad: The resin layers are fragile and do not have sufficient flexibility, and cracking and peeling were generated during formation of the circuit pattern and bonding.

TABLE 4

| | | Example | | | | Comparative Example | | | | |
|---|---|---|---|---|---|---|---|---|---|---|
| | | 1 | 2 | 3 | 4 | 1 | 2 | 3 | 4 | 5 |
| Thickness of the | Varnish A | 7 | 3 | | | 40 | | | | |
| three-dimensional | Varnish B | | | 15 | 30 | | | 40 | | |
| cross-linking type | | | | | | | | | | |
| thermosetting resin layer | | | | | | | | | | |
| (μm) t1 | | | | | | | | | | |
| Thickness of the | Varnish C | 25 | 30 | | | | 40 | | | |
| thermoplastic resin layer | Varnish D | | | 25 | 10 | | | | 40 | 25 |
| (μm) | | | | | | | | | | |
| Thickness of the organic | Varnish A | 8 | 7 | | | | | | | |
| resin layer (μm) | Varnish B | | | | | | | | | 15 |

| | | | | | | | | | |
|---|---|---|---|---|---|---|---|---|---|
| Total thickness of the resin layers | 40 | 40 | 40 | 40 | 40 | 40 | 40 | 40 | 40 |
| (μm) t2 | | | | | | | | | |
| Thickness ratio (t1/t2) | 18/100 | 5/100 | 38/100 | 75/100 | 100/100 | 0/100 | 100/100 | 0/100 | 0/100 |
| Glass transition point (° C.) | — | — | — | — | 330 | 180 | 350 | 330 | — |
| Heat resistance of the surface | Good | Good | Good | Good | Good | Bad | Good | Bad | Bad |
| of the resin layers | | | | | | | | | |
| Flip chip bonding property | Excellent | Good | Excellent | Excellent | Bad | Fair | Bad | Fair | Fair |

It is clear from Table 4 that since the thermoplastic resin layer is laminated on the three-dimensional cross-linking type thermosetting resin layer onto the metallic layer, deformation such as melting and flowing is not observed in the evaluations of heat resistance of the surface of the resin layers and flip chip bonding property in the flexible metallic layered product of the Examples 1 to 4. Thereby, it was confirmed that the flexible metallic layered product of the Examples 1 to 4 has excellent heat resistance and pressure resistance. In contrast, in the flexible metallic layered product in the Comparative Examples 2 and 4, which comprises only the thermoplastic resin layer and the flexible metallic layered product in the Comparative Example 5, which comprises the three-dimensional cross-linking type thermosetting resin layer on the metallic layer via the thermoplastic resin layer contacting the metallic layer, since heat, which exceeds the glass transition point of the resin comprising the thermoplastic resin layer, was applied, serious deformation, that is, melting was generated. In the Comparative Examples 1 and 3, deformation such as melting and flowing in the resin layer, which contacts the metallic layer, was not observed in the heat resistance evaluation of the surface of the resin layers, but the resin layer is very fragile and lacks flexibility, and cracking and peeling were generated during formation of the circuit pattern and bonding.

### INDUSTRIAL APPLICABILITY

The flexible metallic layered product of the present invention has improved heat resistance of the total resin layers, compared with a conventional flexible metallic layered product. Therefore, the flexible metallic layered product of the present invention is suitably used for a flexible printed substrate, which is required to have high heat resistance, in particular, for a semiconductor device, in which an IC chip (semiconductor integrated circuit chip) is laminated on the printed substrate for a semiconductor integrated circuit (IC) comprising an insulating layer and a conductor circuit. In addition, the flexible metallic layered product of the present invention is excellent as a flexible printed board, which is used for flip chip bonding, which is required to have high heat resistance and high pressure resistance.

1. A flexible metallic layered product comprising at least a three-dimensional cross-linking type thermosetting resin layer and a thermoplastic resin layer are layered on a metallic layer in this order.

2. A flexible metallic layered product according to claim 1, wherein a ratio (t1/t2) between the thickness (t1) of the three-dimensional cross-linking type thermosetting resin layer and the thickness (t2) of the total resin layers, which are layered on the metallic layer, is in a range from 7/100 to 85/100.

3. A flexible metallic layered product according to claim 1, wherein the three-dimensional cross-linking type thermosetting resin layer includes at least one of a maleimide derivative, a bisallylnadimide derivative, and an allylphenol derivative.

4. A flexible metallic layered product according to claim 1, wherein the three-dimensional cross-linking type thermosetting resin layer includes a three-dimensional cross-linking type thermosetting resin having at least two reactive functional group in a molecule and a thermoplastic resin which is dissolved in a solvent.

5. A flexible metallic layered product according to claim 1, wherein the thermoplastic resin layer includes at least one of a polyimide resin, a polyamide imide resin, a polyether imide resin, a polysiloxaneimide resin, a polyether ketone resin, and a polyether ether ketone resin.

6. A flexible metallic layered product according to claim 1, wherein an organic resin layer is layered onto the thermoplastic resin layer.

7. A flexible metallic layered product according to claim 1, wherein the metallic layer is one of a copper foil, a stainless steel foil, an aluminum foil, and a steel foil.

8. A flexible metallic layered product according to claim 1, wherein the three-dimensional cross-linking type thermosetting resin layer includes a thermoplastic resin (A) having at least one imide group, a thermosetting compound (B) having at least two maleimide groups, and a compound (C) having a function which is reactive with the thermosetting compound (B).

9. A flexible metallic layered product according to claim 8, wherein the content of the component (A) is in a range from 15 to 85% by weight relative to 100% by weight of the total solid content of the three-dimensional cross-linking type thermosetting resin layer.

10. A flexible metallic layered product according to claim 8, wherein the molar equivalent of the functional group in the component (C) relative to 1 molar equivalent of the functional group in the component (B) is in a range from 2.0 to 0.1.

11. A flexible metallic layered product according to claim 8, wherein the component (A) is at least one of a soluble polyimide resin, a soluble polyamide imide resin, and a soluble siloxane modified polyimide resin.

12. A flexible metallic layered product according to claim 8, wherein the component (C) is at least one resin of a phenol resin, an (iso)phthalate resin, and an (iso)cyanurate resin, and which has at least two functional groups of an allyl group and/or a methallyl group.

13. A flexible metallic layered product according to claim 8, wherein the glass transition point of the component (A) is 200° C. or greater.

14. A heat resistance adhesive composition comprising a thermoplastic resin (A) having at least one imide group, a thermosetting compound (B) having at least two maleimide groups, and a compound (C) having a functional group which is reactive with the thermosetting compound (B).
